(19) United States
(12) Patent Application Publication
(10) Pub. No.: US 2021/0118051 A1
(43) Pub. Date: Apr. 22, 2021

(54) SYSTEM AND METHOD FOR DIGITALLY TOKENIZING SECURITIES AND MANAGING SUBSCRIPTION AND DISTRIBUTION TRANSACTIONS

(71) Applicant: 2218716 Alberta Ltd., Calgary (CA)

(72) Inventors: Mike GEE, Calgary (CA); James GRAHAM, Calgary (CA); Barry KREISER, Calgary (CA); Tony LORIA, Calgary (CA)

(73) Assignee: 2218716 Alberta Ltd., Calgary (CA)

(21) Appl. No.: 17/074,243

(22) Filed: Oct. 19, 2020

Related U.S. Application Data
(60) Provisional application No. 62/923,124, filed on Oct. 18, 2019.

(51) Int. Cl. G06Q 40/04; G06Q 50/06

(52) U.S. Cl. CPC G06Q 40/04; G06Q 50/06

(57) ABSTRACT

There is disclosed a system and method for issuing digital securities, In an embodiment, the method comprises: generating in a blockchain network one or more digital securities tokens representing a tradeable royalty unit governed by a royalty smart contract; managing distribution of the one or more digital securities tokens via one or more nodes participating in the blockchain network; and utilizing one or more nodes outside the blockchain network to enable participation in a royalty pool of the one or more digital securities tokens by a plurality of unitholders outside the blockchain network.

### CROSS-REFERENCE TO RELATED APPLICATIONS

This application claims the benefit of U.S. Provisional Application No. 62/923,124, filed on Oct. 18, 2019, the entirety of which is incorporated herein by reference.

### FIELD OF THE INVENTION

The present disclosure relates generally to digital securities and management of subscription and distribution transactions.

### BACKGROUND

Emerging technologies such as blockchain and digital currencies are opening a wider universe of creative financial products. This digital transformation of global markets is providing new opportunities for companies to successfully realize value for assets, raise capital and access new investors—even in challenging economic conditions.

One such area of growth is the development of securities token offerings (STOs) and the automation of certain transactions associated with these STOs.

However, successfully offering STOs and making them easily accessible through existing classical systems and processes (e.g. existing recognized public market exchanges) continues to be a challenge, as disparate and incompatible data architectures and platforms operated by various participating parties (e.g. agents, banks, dealers, etc.) may make interfacing complex.

Recently, the Seychelles national stock market became the first classical system to list a public equity in the form of a token: a unit of ownership in the MERJ Exchange itself. Plans for token listings have been publicized by digital exchanges currently under development by the Gibraltar Bourse, the Swiss-based SDX Exchange and others. However, the interface between classical markets and newly forming digital securities tokens remains a challenge to be solved.

What is therefore needed is an improved system and method for digitally tokenizing and managing digital securities to enable a flexible approach to interfacing with many existing disparate classical systems and processes operated by various market participants.

### SUMMARY

The present disclosure relates generally to a system and method for tokenizing digital securities and managing securities token subscription and distribution transactions in a transaction network.

In one embodiment, the system and method provides a blockchain-enabled system for the listing of royalties as represented by security tokens listed directly on conventional stock exchanges. Through participation in these digital securities token issuances, royalty issuers (e.g. producers and owners of assets) can obtain fair, accretive value and wide market exposure for their royalty assets. Designed to overcome many of the challenges to royalty investment in existing classical markets, the digital royalty securities offerings enabled by the present system and method offer a purer commodity exposure with a higher yield and lower cost base than conventional royalty company equities can provide.

The present system and method is enabled by recent advances in blockchain infrastructure, combined with a novel process which provides a bridge between traditional market exchanges and asset-backed security tokens. With a wide range of future applications, this new interface allows for the public listing of digital securities token products in a way that overcomes the capital limitations and perceptual challenges currently faced by specialized digital exchanges.

In an embodiment, the system/method is configured to generate a digital securities token representing a tradeable royalty unit as issued by a producer or owner of an asset. The securities token is governed by a smart contract between multiple parties, executing on a contract management node. The digital securities token is managed by a transfer agent which transfers the digital securities tokens via one or more digital trading exchanges. Various dealer nodes may interact with the digital trading exchanges to distribute the tradeable royalty units to various unit holders.

In another embodiment, the contract offered by the producer node is a royalty smart contract which offers a fractional share in royalty revenue from an asset. The royalty revenue may be generated from a wide range of assets, from oil and gas production to mining to copyright and related agreements on music and film holdings, for example. In summary, the royalty smart contract may be directed to any type of royalty contract where multiple parties may receive fractional royalties.

Advantageously, generating a digital securities token representative of tradeable royalty units allows a wide range of unit holders to participate in a royalty securities offering by making the securities transparent with the participation of intermediary parties who can validate the digital securities on offer by a producer/owner of an asset, and avoid directly interacting with a producer/owner of an asset which may increase risk for investors.

Furthermore, the present system and method allows secondary fractionalization of royalty securities by allowing intermediaries to issue and further subdivide royalty payments under digital securities tokens.

In this respect, before explaining at least one embodiment of the invention in detail, it is to be understood that the invention is not limited in its application to the details of construction and to the arrangements of the components set forth in the following description or the examples provided therein, or illustrated in the drawings. Therefore, it will be appreciated that a number of variants and modifications can be made without departing from the teachings of the disclosure as a whole. Therefore, the present system, method and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present system and method will be better understood, and objects of the invention will become apparent, when consideration is given to the following detailed description thereof. Such description makes reference to the annexed drawings, wherein:

FIG. 1 shows a schematic diagram of a transaction network in accordance with an embodiment.

FIG. 2 shows a schematic diagram of a transaction network in accordance with another embodiment.

FIG. 3 shows a schematic process diagram illustrating the transfer of tokens between various nodes of parties to the transaction network.

FIG. 4A shows a schematic diagram of a digital securities token in accordance with an embodiment.

FIG. 4B shows a schematic diagram of the digital securities tokens as may be held in an off-ledger pooled trust.

FIG. 5 shows a schematic block diagram of a generic computing device which may provide an operating environment for various embodiments.

FIG. 6 shows a schematic block diagram of a transaction network comprising a plurality of computer system nodes connected to a network.

In the drawings, embodiments are illustrated by way of example. It is to be expressly understood that the description and drawings are only for the purpose of illustration and as an aid to understanding, and are not intended as describing the accurate performance and behavior of the embodiments and a definition of the limits of the invention.

### DETAILED DESCRIPTION

As noted above, the present invention relates to the field of digital securities and management of subscription and distribution transactions in a transaction network.

The present disclosure relates generally to a system and method for tokenizing digital securities and managing securities token subscription and distribution transactions in a transaction network.

In one embodiment, the system and method provides a blockchain-enabled system for the listing of royalties as security tokens directly on conventional stock exchanges. Through participation in these digital securities token issuances, producers/asset owners can obtain fair, accretive value and wide market exposure for their royalty assets. Designed to overcome many of the challenges to royalty investment, the digital royalty securities offerings enabled by the present system and method offer a purer commodity exposure with a higher yield and lower cost base than conventional royalty company equities can provide.

The present system and method is enabled by recent advances in blockchain infrastructure, combined with a novel process which provides a bridge between traditional market exchanges and asset-backed security tokens. With a wide range of future applications, this new interface allows for the public listing of digital securities token products in a way that overcomes the capital limitations and perceptual challenges currently faced by specialized digital exchanges.

In an embodiment, digital royalty securities tokens are utilized to embody fractionalization of royalty asset ownership, with the potential to be highly accretive to royalty producers and allow investors to access new opportunities for safe, high-yielding listed products via a secure transactional network.

Asset-backed and fully regulatory compliant, the model of royalty issuance and investment as enabled by the present system and method is anticipated to be a rapidly adopted model in security token distribution through traditional market infrastructures and systems.

As a recent investment product venue, specialized digital exchanges are still limited in adoption and lack the full range and scale of capital available through conventional markets. Enabled by the present system and method, the listing of attractive, value-producing asset-backed digital securities tokens in a well-regulated traditional market will be unique.

Providing commodity exposure without risks, for example: exploration and production mismanagement or expense increases in the oil and gas sector, most royalty companies trade at a material premium to net asset value and experience relatively low value decline due to market changes or perception. However, investors seeking royalty products in the public equity markets contend with high management fees, tax exposure and the risk of uncertain contract or value data.

Increasingly, capital has flowed toward energy commodities rather than producer equities, leading to low multiples and restricted access to capital. Royalties are a major source of financing for energy producers and entertainment industry participants. However, they also experience challenges when selling royalty interests. Issues include tax liabilities on sale, lengthy delays between production and royalty calculation, value uncertainty priced into the market and few alternatives beyond a limited pool of buyers. These factors create an ideal use case for combining the automation, transparency and efficiency of blockchain and smart contract technologies with the security tokenization of royalties, as described and enabled by the present system and method.

In an embodiment, by adding a digital securities token layer on top of an existing licensing agreement represented by a smart contract, fractionalized units as represented by the digital securities tokens are issued with entitlement to a defined percentage of the revenue. The resulting asset is distributed pre-tax, unlike royalty sales, and at a higher value to the producer than through typical transactions.

With a verified, immutable chain of production data auditable through the Energy Block Exchange or EBX, the timeline from extraction to royalty calculation is shortened, and self-executing smart contracts enable streamlined transactions with dramatically reduced dispute delays and costs. This allows for an innovative investment product with superior exposure to the underlying commodity and high resistance to market forces, while being far more accretive to the producer than conventional royalty models.

The digital foundation enabling the tradable royalties in accordance with the present system and method is built on the international banking consortium R3's open-source Corda platform, the most trusted and effective blockchain infrastructure for the financial services industry. A permissioned network with high data security and unparalleled scalability, Corda's large volume capacity for transactions per second and incorporation of conventional legal documentation makes it ideal for securities purposes.

EBX, developed on Corda as a blockchain business network for the Oil & Gas industry, is a market-proven solution for streamlining the calculation and settlement of royalty payments on ledger. Reducing the significant lag between production and settlement, EBX allows producers faster execution and payments, lower general and administrative (G&A) expenses and a reduction in frequent, costly payment disputes by automating transactions with smart contracts.

The emergence of new technological solutions has only now created the ability to realize a product like the digital securities tokens in accordance with the present system and method. Hereinafter, these digital securities tokens are also referenced as “Tradeable Royalties” or TROY™, a trademark of 2218716 AB Ltd. (Alberta, Canada).

As will now be explained, the TROY enabled by these present system and method seamlessly bridges security tokenization of assets with conventional exchange infrastructure. When a production event is first registered, e.g. on the EBX exchange, TROY tokens are issued as a royalty-based asset token which is held in trust by a trust entity, such as by a trust corporation, a bank, a legal firm, or other entity able to perform the role of a trustee. This trust entity coordinates the listing of a copy of the TROY digital securities tokens with a secondary exchange through their existing standard format, and immutably holds the digital version, stored securely and indentured in a pooled trust. Acquisition of the product by unitholders and secondary trading to dealers is then facilitated by the secondary exchange.

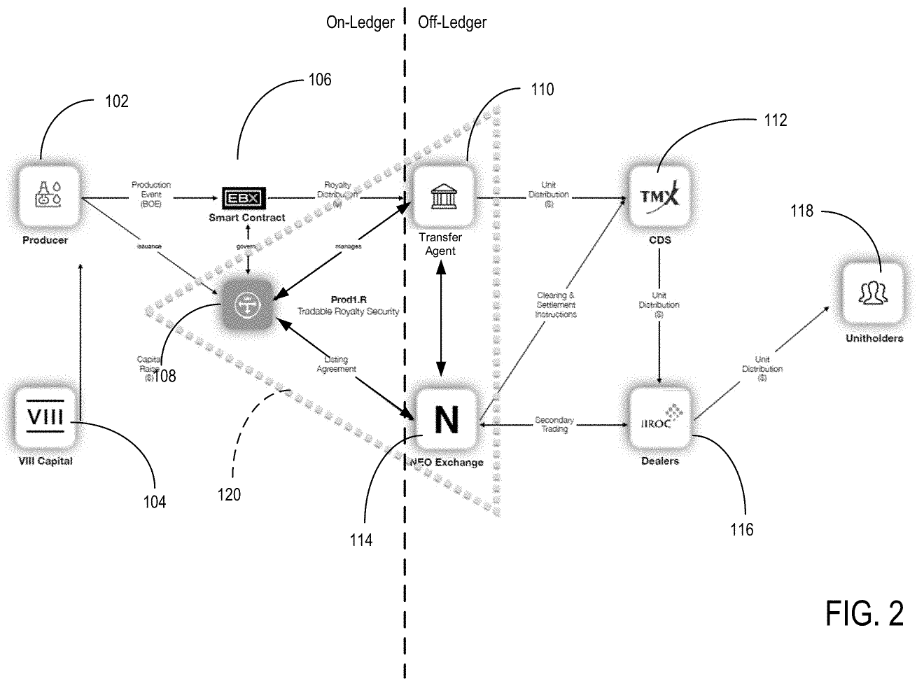

The unique trust structure of the TROY digital securities token means that, unlike with the Seychelles' MERJ token listing as mentioned in the Background section, the transaction details are conducted off-ledger (see FIG. 2 below) and the volume, identity and other details of the unit purchase are kept private from the market. This novel technological feature overcomes a significant barrier for markets in the listing of on-ledger products, where full transaction transparency is non-compliant or otherwise undesirable by investors.

The TROY digital securities token fully defines the standardization and protocols for royalty token listing on the exchange. The relationships between each of the parties involved in the processing of TROY digital securities tokens is delineated by either smart contracts or other legal agreements, and will provision for a variety of corporate or market events including unit buy-backs, royalty issuer default, changes in operating control on the part of involved companies like producers, and alterations to its technologies or structure.

As long as the participating entities are fully complaint with applicable Federal and State/Provincial laws and jurisdictional securities regulations, TROY digital securities tokens can be made available for offer to recognized and approved public exchanges.

The technology behind EBX provides a cost-effective, verified chain of auditable data that increases market trust while reducing compliance expenses. An additional future efficiency is the potential for automated, on ledger reporting of trading information to SEDAR.

Various illustrative embodiments will now be described with reference to the figures.

In an embodiment, the system/method is configured to generate a digital securities token representing a tradeable royalty or TROY unit, as issued by a producer or owner of an asset. A “producer” in the present disclosure refers to any owner of an asset from which a royalty is derived.

The TROY digital securities token is governed by a smart contract between multiple parties, executing on a contract management node. A “node” in the present disclosure refers to a network-enabled computing device which may execute computer readable program instructions to execute a computer program which allows the computing device to participate as a peer in a transaction network or blockchain network.

The TROY digital securities token is managed by a transfer agent, such as a trust company, which transfers the digital securities tokens via one or more digital trading exchanges. Various dealer nodes may interact with the digital trading exchanges to distribute the tradeable royalty units to various unit holders.

By way of example, in an embodiment, the contract offered by the producer node is a royalty smart contract which offers a fractional share in royalty revenue from an asset. The royalty revenue may be generated from a wide range of assets, ranging from oil and gas production, to copyright royalties and related agreements derived from music and film catalog holdings, for example. In summary, the royalty smart contract may be directed to any type of royalty contract where multiple parties may receive fractional royalties generated from a royalty bearing asset.

Various illustrative embodiments will now be described with reference to the figures.

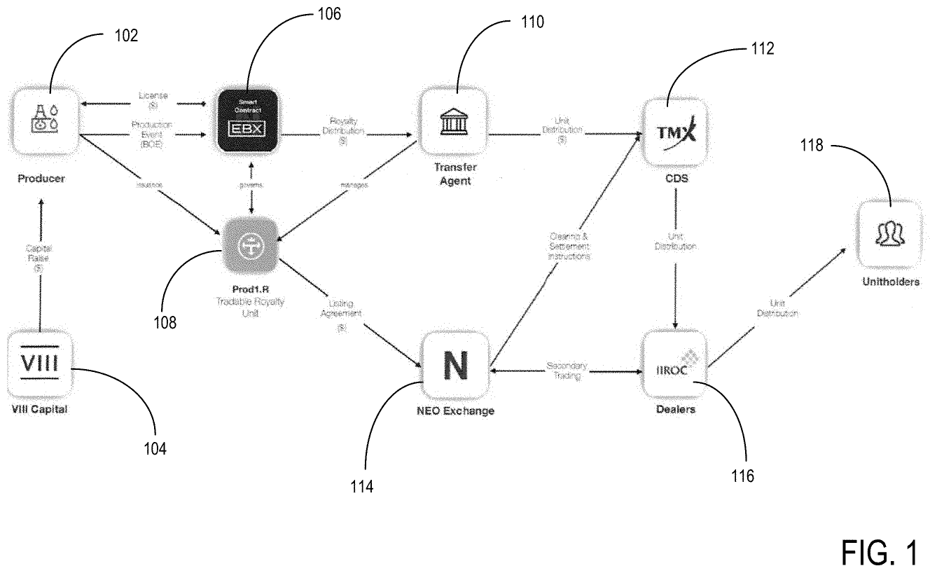

Referring to FIG. 1, shown is a schematic block diagram of a transaction network in accordance with an embodiment. Now describing the blocks at a high level, block 102 represents a producer node which, together with an investment advisor node 104, interacts with a smart contract management node 106 to issue a digital securities token 108, representing a tradable royalty unit offered by the producer node 102. This digital securities token 108 is governed by the terms of the smart contract executing on the smart contract management node 106. The digital securities token 108 is managed by a transfer agent 110 which receives a royalty distribution from the smart contract management node 106 and transfers a unit distribution via an exchange securities depository node 112 to one or more dealer nodes 116.

In an embodiment, secondary exchange node 114 receives details of agreement for the digital securities token 108, and provides clearing and settlement instructions to exchange securities depository node 112. Secondary exchange node 114 also facilitates secondary trading directly with one or more dealer nodes 116.

Unit holder nodes 118 interact with dealer nodes 116 to receive unit distributions originally issued by smart contract management node 106.

Now referring to FIG. 2, shown is another embodiment of the transaction network of FIG. 1 in which a TROY management portion 120 of the transaction network includes a smart contract management node 106, a transfer agent node 110, and optionally a secondary exchange node 114. These nodes cooperate to manage the subscription to the digital securities token 108 representing a tradable royalty securities offered by producer node 102. In this example, transfer agent node 110 is a trust company which directly manages the digital securities token 108, and its listing on secondary exchange 114. Here, the transfer agent node 110 receives a royalty distribution from the smart contract management node 106, and makes a unit distribution to exchange securities depository node 112. Secondary exchange 114 initiates clearing and settlement instructions which allow unit distribution from the exchange securities depository node 112 to be transferred to one or more dealer nodes 116.

Still referring to FIG. 2, as illustrated, the transaction network may be divided into nodes operating “on-ledger”, and other nodes operating “off-ledger”. In the present description, the term “on-ledger” denotes an initial offering to unit holders that is registered on the blockchain, and the creation, distribution and management of the TROY digital securities tokens in the initial offering is fully tracked by the smart contract management node 106. However, certain nodes including a trust agent node 110 and a secondary exchange node 114 may act as intermediaries between the “on-ledger” side of the transaction network, and an “off-ledger” side of the transaction network representing a secondary market comprising nodes in a classical market such as public exchange nodes 112, dealer nodes 116, and unitholder nodes 118. This secondary offering is “off-ledger” in the sense that the TROY tokens are held in a royalty pool which allows participation by a much wider number of unitholder nodes that otherwise would not have access to the TROY digital securities tokens made available in the initial offering.

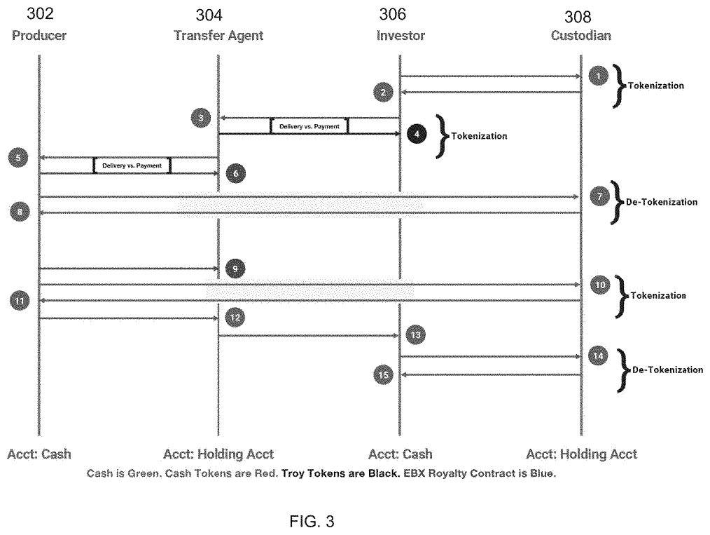

Now referring to FIG. 3, shown by way of example, and not by way of limitation, is a schematic process diagram illustrating the transfer of tokens between various nodes of parties to the transaction network.

In this illustrative embodiment, at process step one, an investor node 306 electronically wires cash to a custodian node 308 in order to issue cash tokens.

At process step two, node 308 issues cash tokens which are then sent to the investor node 306.

At process step three, investor node 306 transfers the cash tokens issued by the custodian node 308, and it sends the cash tokens to the transfer agent or transfer agent node 304.

At process step four, transfer agent node 304 issues digital securities tokens 108 which are sent to investor node 306, or which are held by an intermediary on behalf of the investor node 306.

At process step five, transfer agent node 304 transfers cash tokens to a producer node 302 (via smart contract management node 106).

At process step six, producer node 302 issues a royalty smart contract to transfer agent node 304 (via smart contract management node 106).

At process step seven, producer node 302 sends cash tokens to custodian node 308 in order to de-tokenize the digital security.

At process step eight, the producer node electronically wires cash back to producer node 302.

In summary, process steps one through eight are eight occur during the investment stage, as one or more subscribers are unit holders invest in the digital security tokens 108 through one or more investor nodes 306.

Still referring to FIG. 3, the process steps involved in distributing a royalty payment will now be described.

At process nine, producer node 302 triggers the royalty smart contract executing on smart contract management node 106 and computes a royalty payment obligation.

At process step ten, producer node 302 electronically wires cash to custodian node 308 in order to generate cash tokens for the royalty payment obligation.

At process step eleven, producer node 308 issues the cash tokens requested and paid for by producer node 302, and sends the cash tokens to producer node 302.

At process step twelve, producer node 302 sends the cash tokens to transfer agent node 204 to settle the royalty smart contract obligation.

At process step thirteen, transfer agent node 304 in turn sends the cash tokens to one or more investor nodes 306 via various intermediaries, as previously illustrated in FIG. 1 and FIG. 2.

At process step fourteen, one or more investor nodes 306 can send the cash tokens to custodian node 308, in order to convert the cash tokens back to cash currency. Custodian node 308 electronically wires cash back to the one or more investor nodes 306 in order to complete the royalty dissertation process.

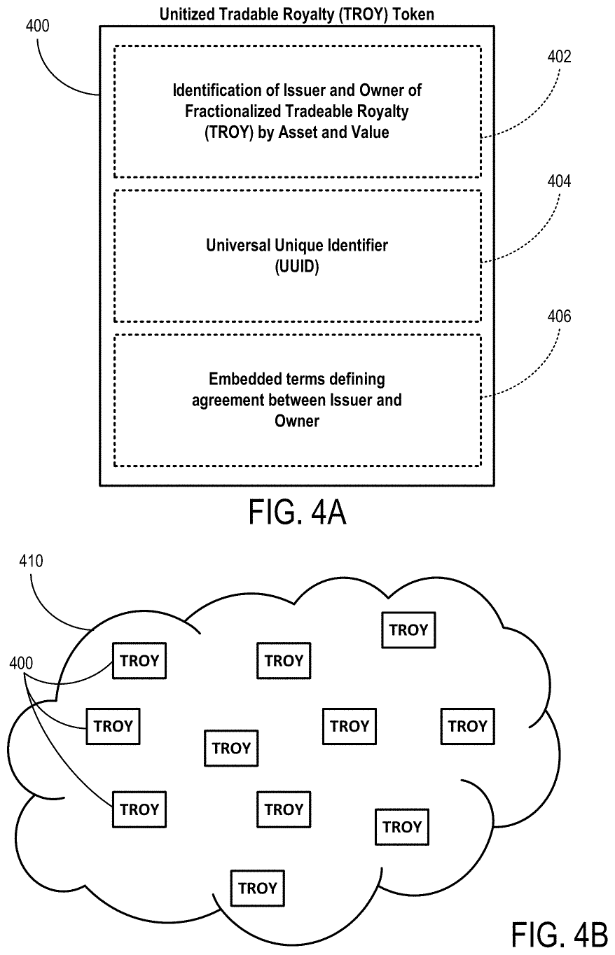

Now referring to FIGS. 4A and 4B, shown is an illustrative schematic representation of a TROY digital securities token 400 in accordance with an embodiment.

In FIG. 4A, a TROY digital securities token 400 is illustrated as a unitized token having a first digital component 402 representing identification of an Issuer and an Owner of Fractionalized Tradeable Royalty (TROY) by Asset and Value, a second digital component 404 representing a universal unique identifier (UUID) uniquely identifying the token, such as a serial number, and a third digital component 406 comprising embedded terms for defining an agreement between the Issuer and Owner. These terms may reference a node or document where such terms are detailed.

In FIG. 4B, shown is an illustrative off-ledger royalty pool 410 in which TROY units are held in trust by a trust entity (e.g. trust entity 110 and/or a secondary exchange 114 as previously described with respect to FIG. 1 and FIG. 2). This royalty pool made available to the classical market enables participation by a large number of unitholders, as represented by unitholder nodes 118, who can now access these TROY digital royalties securities which otherwise would have been unavailable to them.

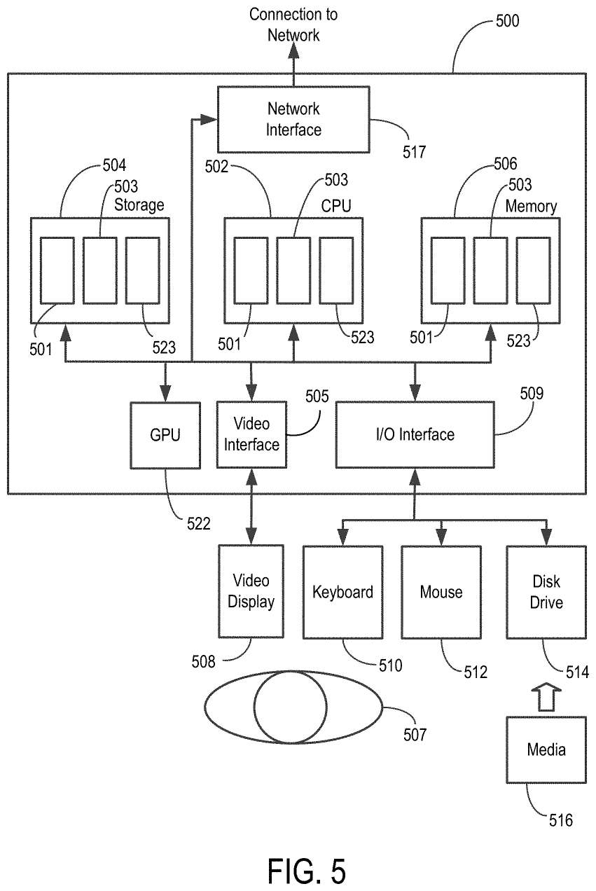

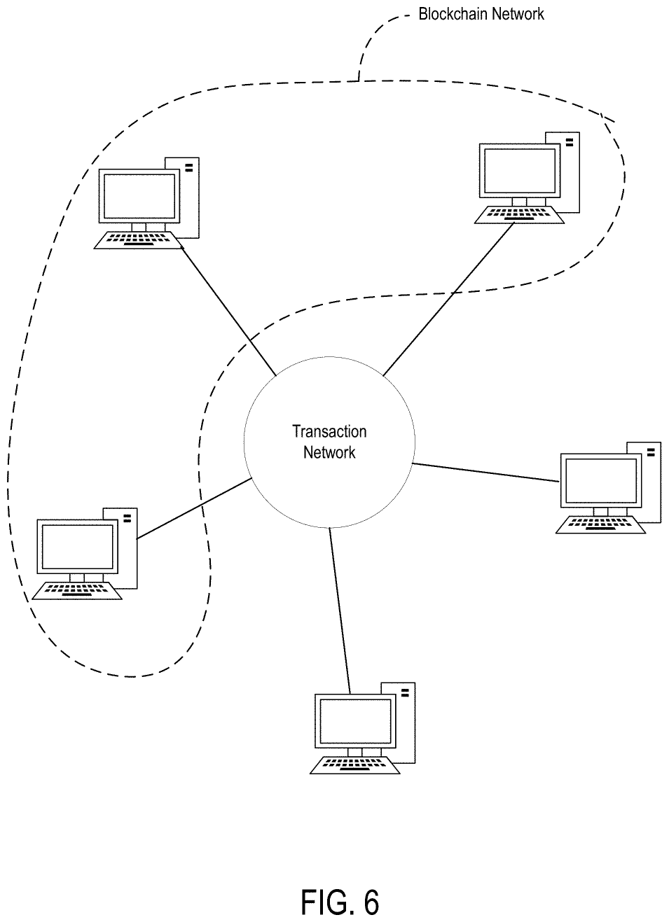

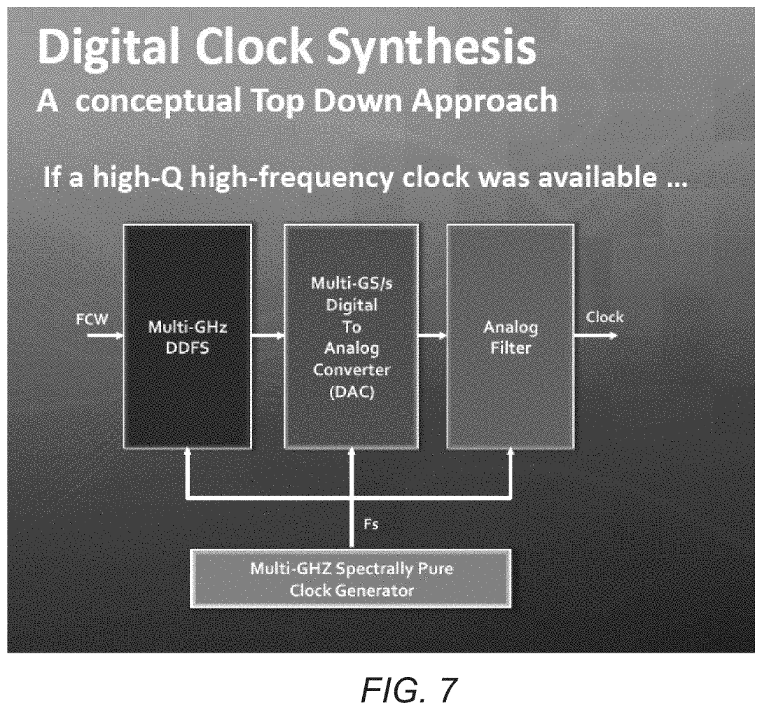

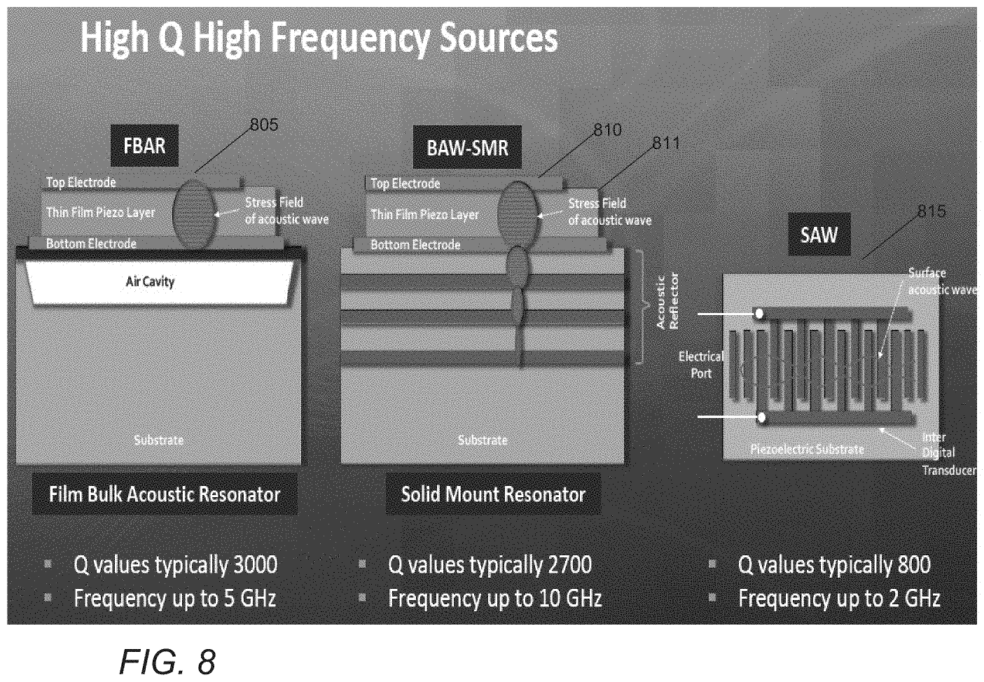

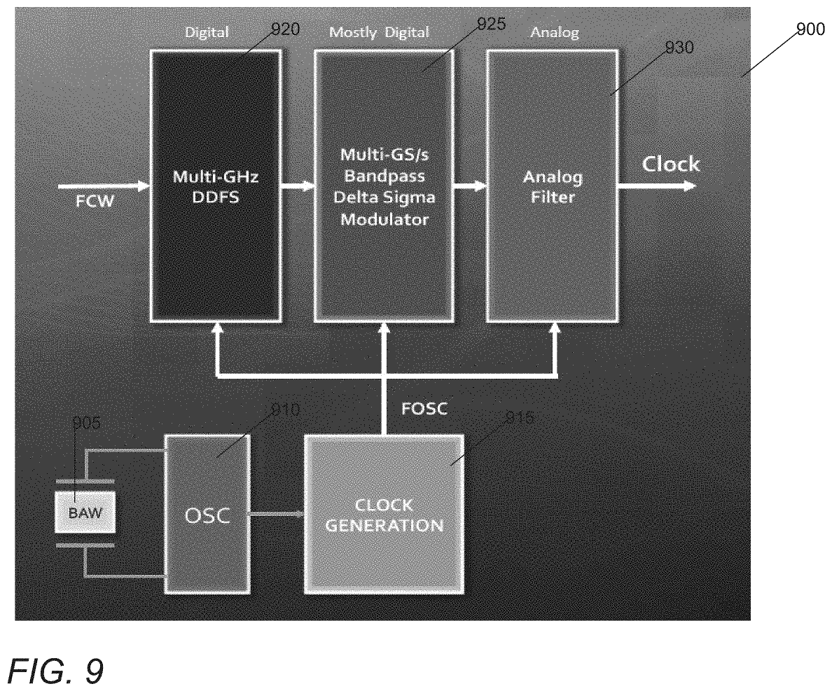

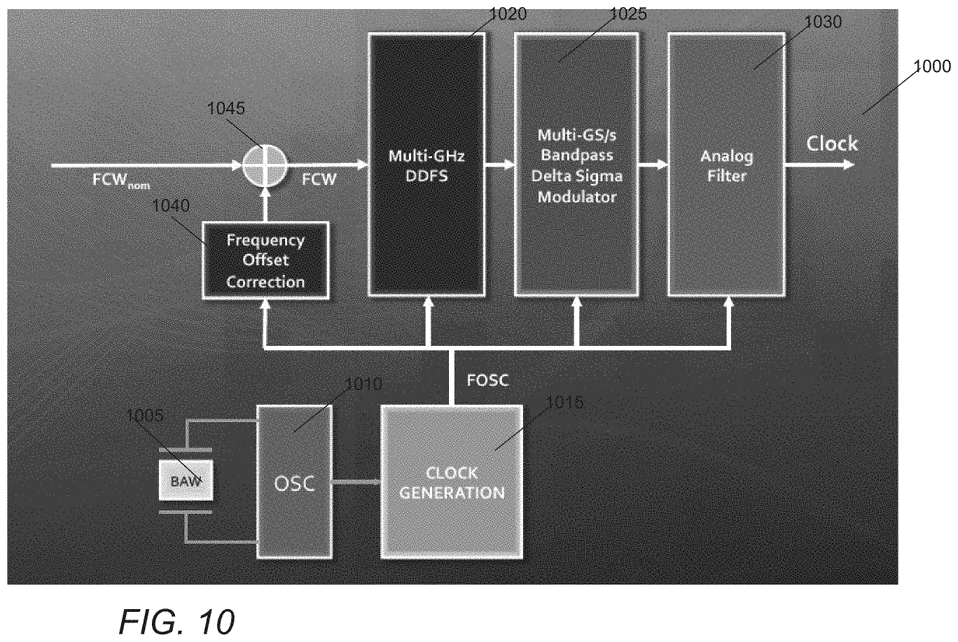

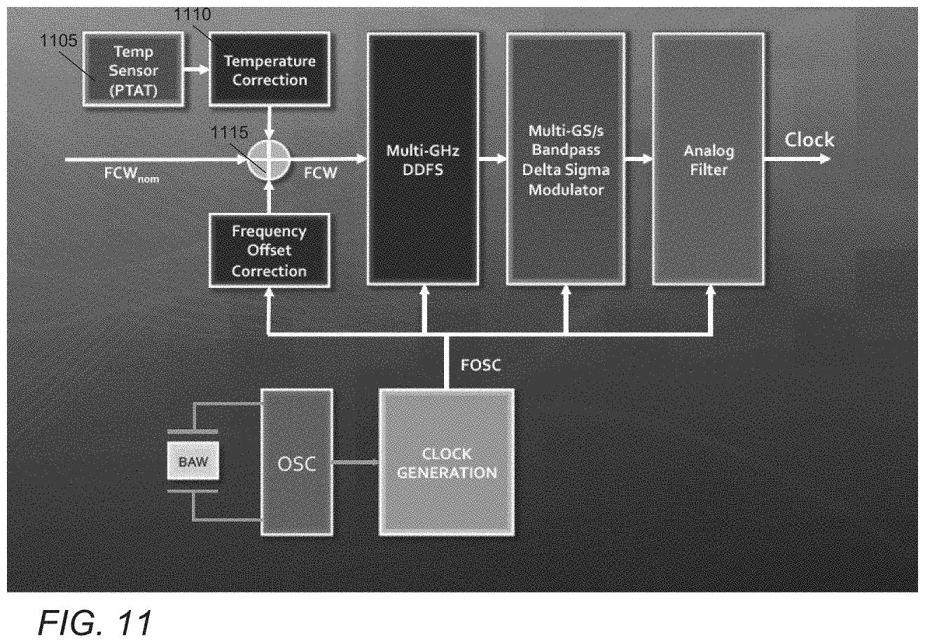

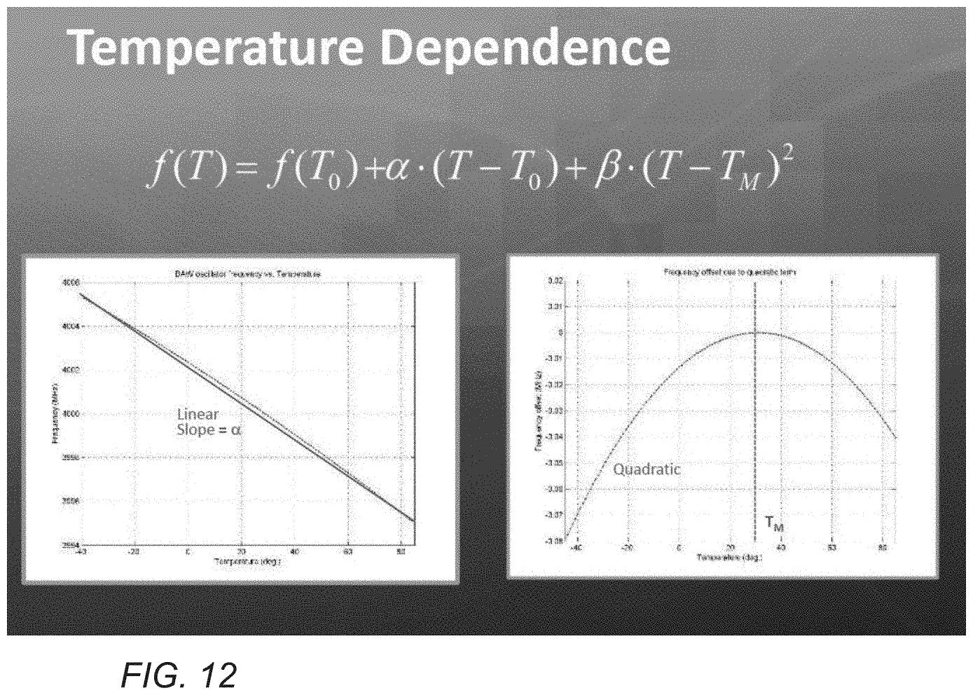

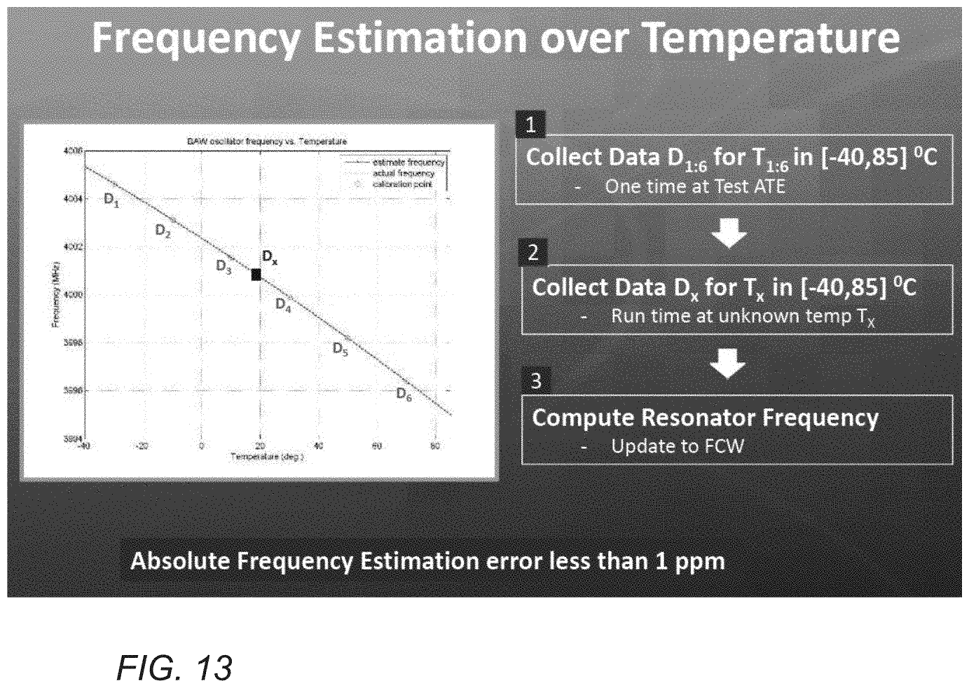

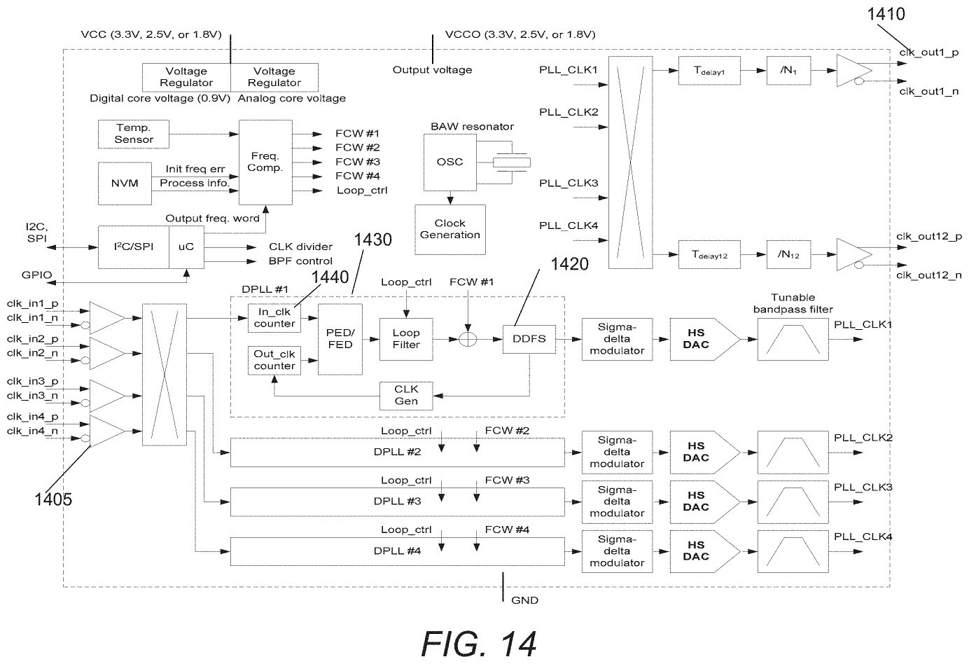

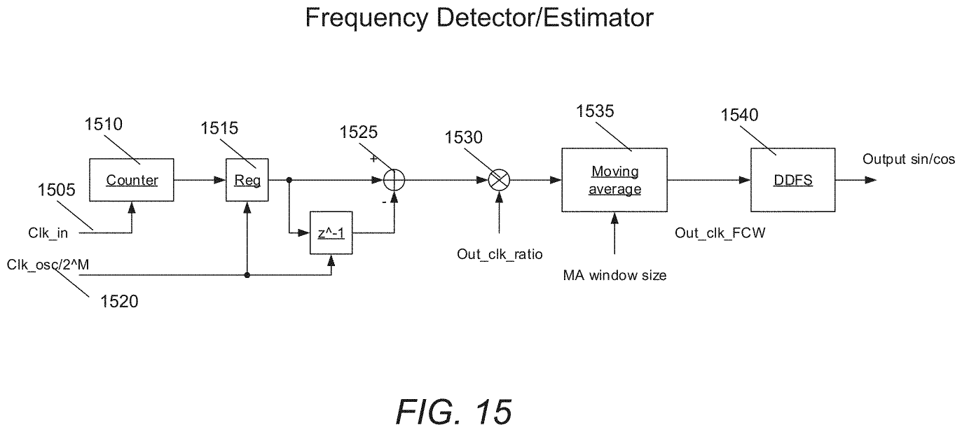

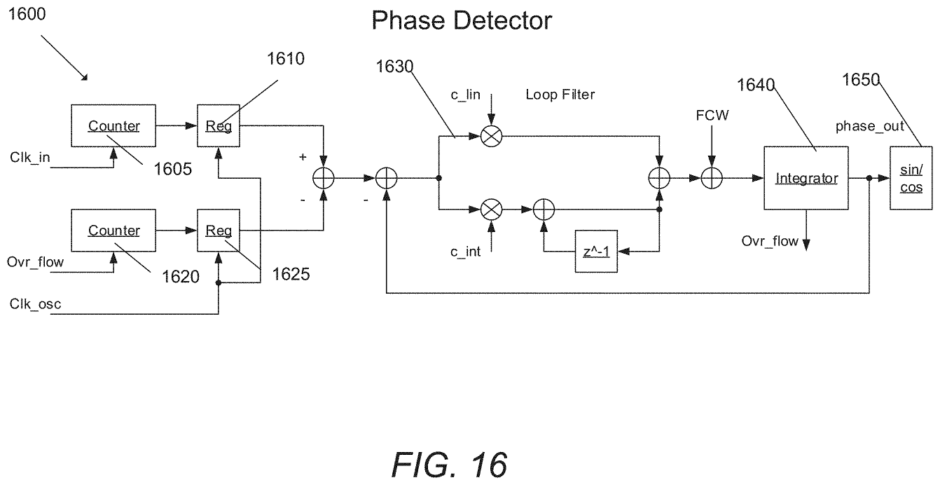

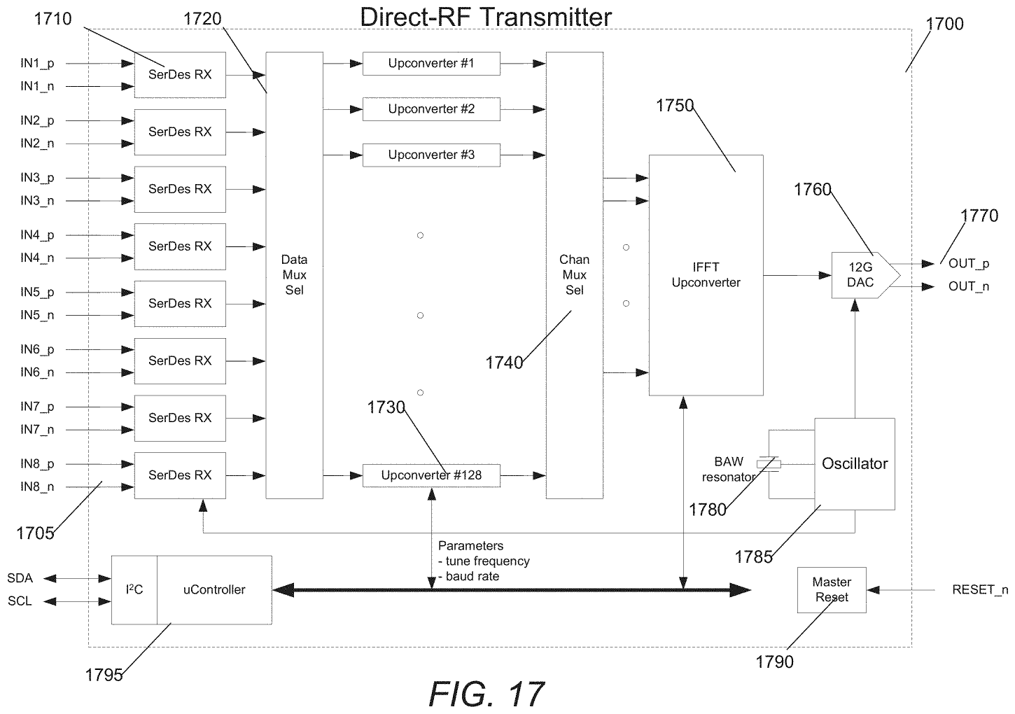

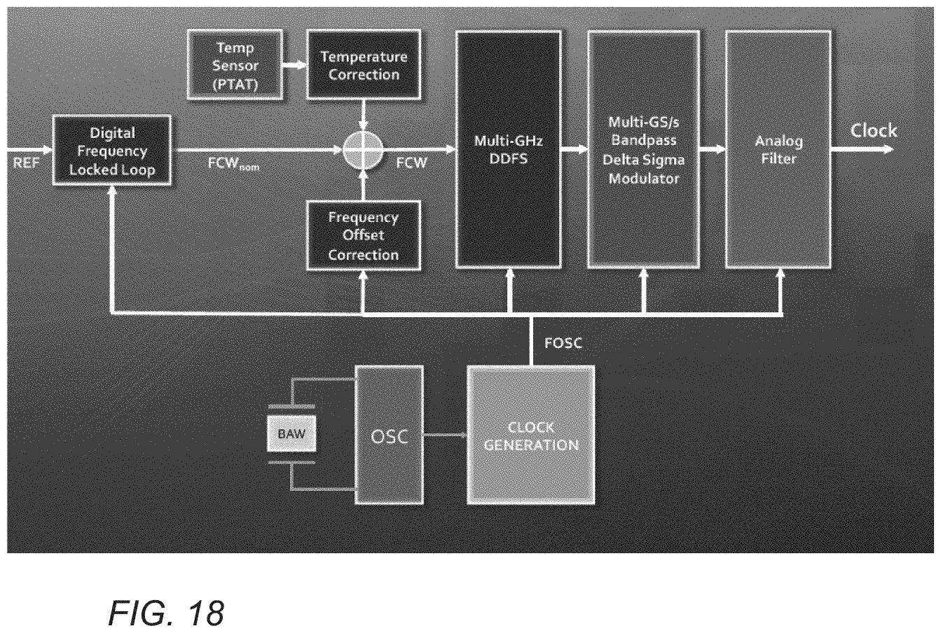

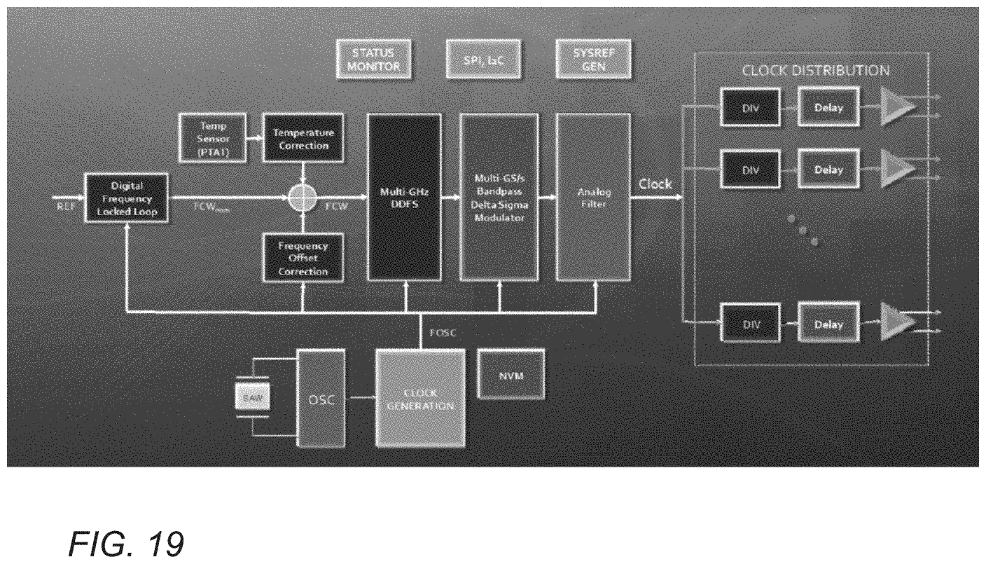

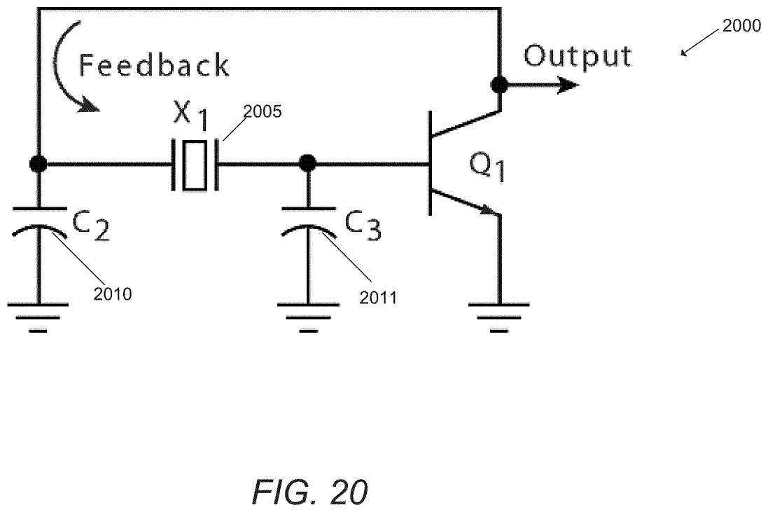

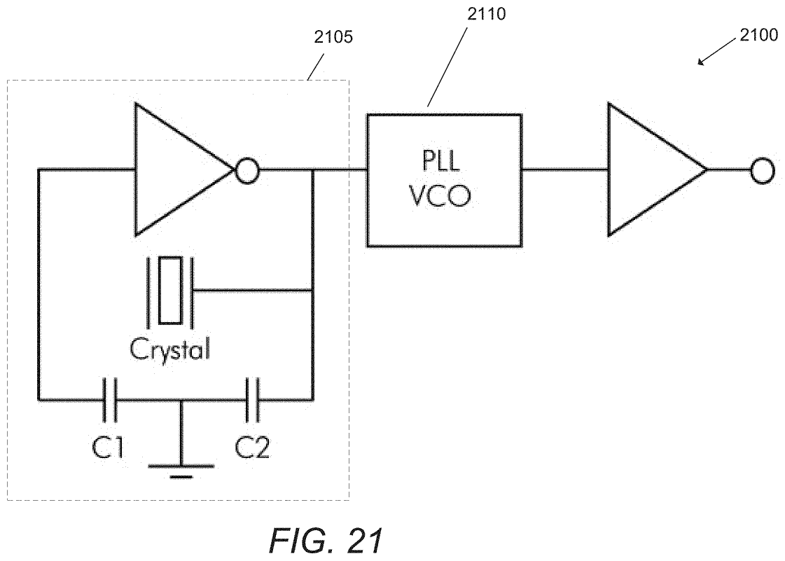

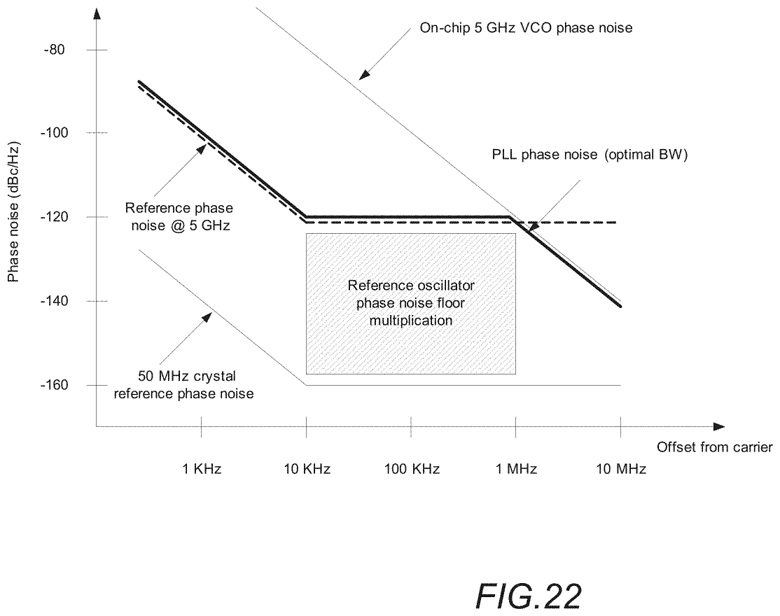

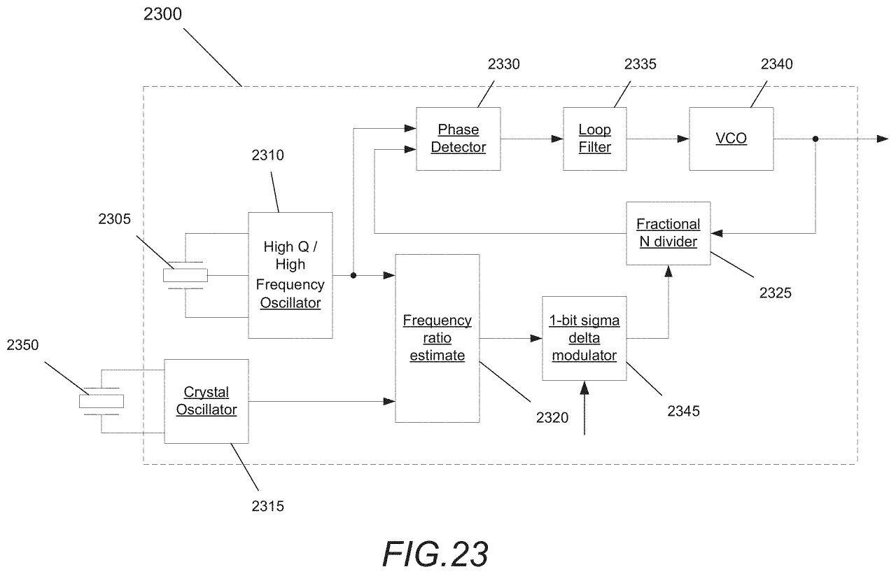

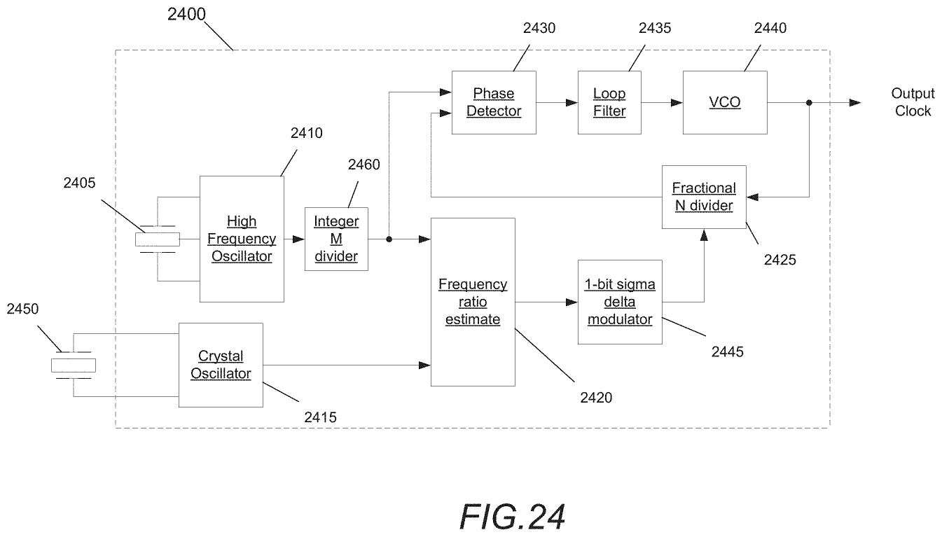

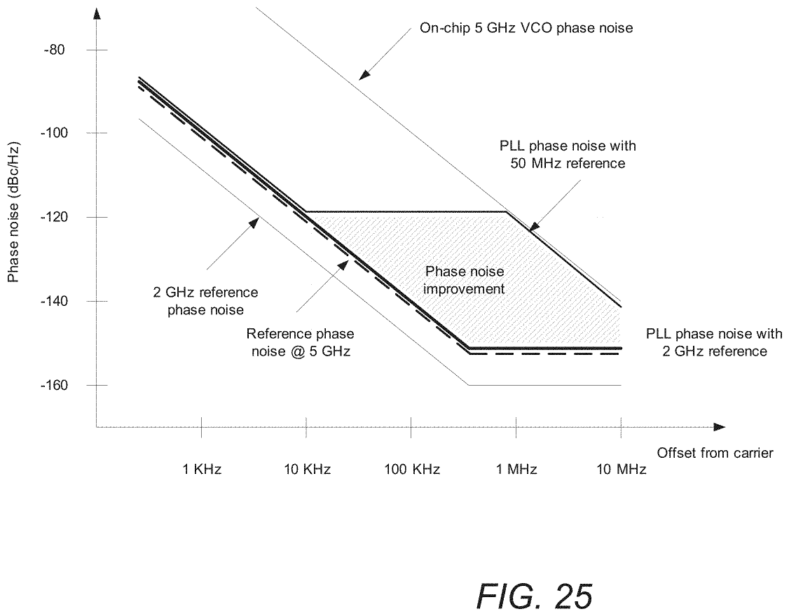

Now referring to FIG. 5 shown is a schematic block diagram of a generic computing device that may provide a suitable operating environment in one or more embodiments. A suitably configured computer device, and associated communications networks, devices, software and firmware may provide a platform for enabling one or more embodiments as described above. By way of example, FIG. 5 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 510 may interact with the computer device 500 using a video display 508 connected by a video interface 505, and various input/output devices such as a keyboard 510, pointer 512, and storage 514 connected by an I/O interface 509. In known manner, the pointer 512 may be configured to control movement of a cursor or pointer icon in the video display 508, and to operate various graphical user interface (GUI) controls appearing in the video display 508. The computer device 500 may form part of a network (see FIG. 6) via a network interface 511, allowing the computer device 500 to communicate with other suitably configured data processing systems or circuits. A non-transitory medium 516 may be used to store executable code embodying one or more embodiments of the present method on the generic computing device 500.

Now referring to FIG. 6, shown is a schematic block diagram of a transaction network comprising a plurality of computer devices in accordance with an embodiment. The computer devices may provide a platform for each of the nodes described above with reference to FIGS. 1-3. At least some of the nodes may also be a part of a blockchain network hosted by smart contract management node 106, with each of the participating contracting nodes having access to the smart contract via the virtual blockchain network. Other nodes that interact with a node in the blockchain network but do not need direct access to the smart contract rely on their connection to the participating node to access information they need and are entitled to for the purposes of the transaction network.

### Advantages

An illustrative example of a use case will now be described with reference to the system and method as described above with reference to FIGS. 1 to 6.

In this example, the producer is an oil and gas company with a lease to produce oil from a fracking operation. In order to raise operating capital, the oil and gas company works with an investment advisor, a trust company, and a smart contract manager to issue digital securities tokens representing a tradeable royalty unit in royalties produced by the fracking operation.

The digital securities tokens may represent fractional royalties in the royalty stream to which unit holders of the digital security tokens are entitled. By offering participation in the royalties by way of the digital security tokens, the producer has significantly greater flexibility in making these tradable royalty units available through a trust company working with exchange securities depositories, secondary exchanges, and dealers.

Unit holders wishing to subscribe to the securities do not need to deal directly with the producer, but instead invests in the digital securities tokens offered as investable securities in established securities exchanges through their respective dealers.

Via their respective nodes in the transaction network, intermediary parties cooperate to electronically transfer cash, generate, issue and manage the digital securities tokens, and periodically process the royalty distributions generated by the smart contracts.

Advantageously, the present system and method provides a trusted, secure and safe digital trading platform for both unitholder and producer/asset owner, and has significant benefits for E&P financing and for investors seeking exposure to high yielding royalties at a lower risk.

At a time when capital is challenging to access, TROY provides Oil & Gas companies and other asset owners with an innovative digital financing structure for E&P with a substantial economic improvement over traditional royalty sales. Benefits to royalty issuers include:
Realization of higher value for royalties through a tax-efficient, low-overhead structure
Optionality resulting in greater leverage when negotiating with royalty companies
Reduction in G&A costs for royalty issuance through the efficiencies created by EBX
Access to a wider investment pool increases the producer equity's exposure to the market
Allows for selective public listing of assets by private companies to raise capital
Diverse options for TROY distribution, including to existing shareholders, and the option to buy back units

### Investors

Investment in royalties through rights purchase or royalty-holding equities by investors results in a lack of liquidity or access to only lower-caliber investments eroded by high fees and expenses. TROY enables investors to have:
Investment in higher-quality royalties than typically available through public royalty companies
Simplified, direct exposure to production barrels without high management and tax expenses
High-yielding assets with the potential for upside through producer or other forms of take-out
Royalty investments that overcome trust deficits in the market through the transparency of EBX
The ability to create hedge structures to reduce exposure to market downside
Complete tax elimination by pension funds or other tax-exempt organizations

The present system and method enables a process for integrating the security tokenization of royalties with classical exchange systems enables a wide range of future development potentials.

Any royalty product from virtually any industry can be transacted on public markets using TROY's process, with possibilities ranging from mining and metals and real estate to intangible assets like intellectual property. Other possible royalty products include, but are not limited to, renewable energy and clean tech including solar, wind, biodiesel, and hydro, for example.

For the first time, technology has enabled a bridge between the emerging world of leger-based tokens and traditional market infrastructure, without the requirements or restrictions of fully digital blockchain trading system. Merging the benefits of classical trading platforms with secure, high-yielding fractionalized royalties, TROY is an innovation solution that opens a new spectrum of opportunities for issuers, investors and markets.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

Thus, in an aspect, there is provided a system for issuing digital securities, the system adapted to: generate in a blockchain network one or more digital securities tokens representing a tradeable royalty unit governed by a royalty smart contract; manage distribution of the one or more digital securities tokens via a management node participating in the blockchain network and executing the royalty smart contract; and utilize one or more nodes outside the blockchain network to enable participation in a royalty pool of the one or more digital securities tokens by a plurality of unitholders outside the blockchain network.

In an embodiment, the one or more digital securities tokens representing the tradeable royalty unit are generated by the management node with participation of a producer node.

In another embodiment, the one or more digital securities tokens issued by the management node are adapted to be listed as tradable royalty units on a digital trading exchange.

In another embodiment, the one or more digital securities tokens issued by the management node are listed as tradable royalty units on a digital trading exchange via one or more intermediary transfer agent nodes.

In another embodiment, the system further comprises an interface for publicly listing the digital securities token products on one or more digital trading exchanges.

In another embodiment, various dealer nodes interact with the digital trading exchanges to distribute the tradeable royalty units to various unit holders.

In another embodiment, the royalty smart contract is a multiparty agreement governing fractional sharing in royalty revenue from a production asset.

In another embodiment, the management node is adapted to distribute royalties in accordance with the royalty smart contract.

In another embodiment, the one or more digital securities tokens issued by the management node are asset-backed by a royalty license on production by a producer.

In another embodiment, the production asset is one or more of oil, gas, mining, renewable energy, clean tech, music and film holdings.

In another aspect, there is provided a computer-implemented method executable on a plurality of computer nodes participating in a network for issuing digital securities, the method comprising: generating in a blockchain network one or more digital securities tokens representing a tradeable royalty unit governed by a royalty smart contract; managing distribution of the one or more digital securities tokens via a management node participating in the blockchain network and executing the royalty smart contract; and utilizing one or more nodes outside the blockchain network to enable participation in a royalty pool of the one or more digital securities tokens by a plurality of unitholders outside the blockchain network.

In an embodiment, the method further comprises generating the one or more digital securities tokens representing the tradeable royalty unit on a management node with participation of a producer node.

In another embodiment, the method further comprises adapting the one or more digital securities tokens issued by the management node as tradeable royalty units to be listed on a digital trading exchange.

In another embodiment, the one or more digital securities tokens issued by the management node are listed as tradable royalty units on a digital trading exchange via one or more intermediary transfer agent nodes.

In another embodiment, the method further comprises providing an interface for publicly listing the digital securities token products on one or more digital trading exchanges.

In another embodiment, the method further comprises distributing the tradeable royalty units to various unit holders via one or more dealer nodes interacting with the digital trading exchanges.

In another embodiment, the royalty smart contract is a multiparty agreement governing fractional sharing in royalty revenue from a production asset.

In another embodiment, the method further comprises distributing royalties in accordance with the royalty smart contract via the management node.

In another embodiment, the one or more digital securities tokens issued by the management node are asset-backed by a royalty license on production by a producer.

In another embodiment, the production asset is one or more of oil, gas, mining, renewable energy, clean tech, music and film holdings.

While illustrative embodiments have been described above by way of example, it will be appreciated that various changes and modifications may be made without departing from the scope of the invention, which is defined by the following claims.

1. A system for issuing digital securities, the system adapted to:
generate in a blockchain network one or more digital securities tokens representing a tradeable royalty unit governed by a royalty smart contract;
manage distribution of the one or more digital securities tokens via a management node participating in the blockchain network and executing the royalty smart contract; and
utilize one or more nodes outside the blockchain network to enable participation in a royalty pool of the one or more digital securities tokens by a plurality of unitholders outside the blockchain network.

2. The system of claim 1, wherein the one or more digital securities tokens representing the tradeable royalty unit are generated by the management node with participation of a producer node.

3. The system of claim 2, wherein the one or more digital securities tokens issued by the management node are adapted to be listed as tradable royalty units on a digital trading exchange.

4. The system of claim 3, wherein the one or more digital securities tokens issued by the management node are listed as tradable royalty units on a digital trading exchange via one or more intermediary transfer agent nodes.

5. The system of claim 2, further comprising an interface for publicly listing the digital securities token products on one or more digital trading exchanges.

6. The system of claim 5, wherein various dealer nodes interact with the digital trading exchanges to distribute the tradeable royalty units to various unit holders.

7. The system of claim 1, wherein the royalty smart contract is a multiparty agreement governing fractional sharing in royalty revenue from a production asset.

8. The system of claim 7, wherein the management node is adapted to distribute royalties in accordance with the royalty smart contract.

9. The system of claim 2, wherein the one or more digital securities tokens issued by the management node are asset-backed by a royalty license on production by a producer.

10. The system of claim 9, wherein the production asset is one or more of oil, gas, mining, renewable energy, clean tech, music and film holdings.

11. A computer-implemented method executable on a plurality of computer nodes participating in a network for issuing digital securities, the method comprising:
generating in a blockchain network one or more digital securities tokens representing a tradeable royalty unit governed by a royalty smart contract;
managing distribution of the one or more digital securities tokens via a management node participating in the blockchain network and executing the royalty smart contract; and
utilizing one or more nodes outside the blockchain network to enable participation in a royalty pool of the one or more digital securities tokens by a plurality of unitholders outside the blockchain network.

12. The method of claim 11, further comprising generating the one or more digital securities tokens representing the tradeable royalty unit on a management node with participation of a producer node.

13. The method of claim 12, further comprising adapting the one or more digital securities tokens issued by the management node as tradeable royalty units to be listed on a digital trading exchange.

14. The method of claim 13, wherein the one or more digital securities tokens issued by the management node are listed as tradable royalty units on a digital trading exchange via one or more intermediary transfer agent nodes.

15. The method of claim 12, further comprising providing an interface for publicly listing the digital securities token products on one or more digital trading exchanges.

16. The method of claim 15, further comprising distributing the tradeable royalty units to various unit holders via one or more dealer nodes interacting with the digital trading exchanges.

17. The method of claim 11, wherein the royalty smart contract is a multiparty agreement governing fractional sharing in royalty revenue from a production asset.

18. The method of claim 17, wherein the method further comprises distributing royalties in accordance with the royalty smart contract via the management node.

19. The method of claim 12, wherein the one or more digital securities tokens issued by the management node are asset-backed by a royalty license on production by a producer.

20. The method of claim 19, wherein the production asset is one or more of oil, gas, mining, renewable energy, clean tech, music and film holdings.
